(19) United States
(12) Patent Application Publication
(10) Pub. No.: US 2009/0303180 A1
(43) Pub. Date: Dec. 10, 2009

(54) COMPUTER DISPLAY CONTROL USING MULTIPLE INPUT DEVICES WITH DIFFERENT COMBINATIONS OF INPUT FUNCTIONS

(75) Inventors: Vance Chin, San Francisco, CA (US); Jonathan Betts-LaCroix, San Mateo, CA (US)

Correspondence Address: Trellis Intellectual Property Law Group, PC, 1900 EMBARCADERO ROAD, SUITE 109, PALO ALTO, CA, 94303, US

(73) Assignee: OQO, Inc., San Francisco, CA (US)

(21) Appl. No.: 12/134,980

(22) Filed: Jun. 6, 2008

(51) Int. Cl. G06F 3/033; G09G 5/00

(52) U.S. Cl. 345/157; 345/156

(57) ABSTRACT

In one embodiment, a computing device for providing navigation on a display is provided. The computing device includes a first input device that provides navigation on the display screen in two dimensions. For example, the first input device may be a trackstick or track ball that can be mechanically actuated by a user. When actuated, the first input device may cause a pointing device to move in two dimensions, such as in the X-Y directions. Also, a second input device is provided that is configured to provide navigation on the display screen in one dimension. For example, the second input device may be a scrollwheel that provides movement in the vertical or horizontal direction. The second input device is situated around the first input device and is configured to be physically turned around the first input device.

### BACKGROUND

Particular embodiments generally relate to computing devices.

When using a computing device, a user may want to navigate around content displayed on a display screen. For example, a user may want to move a pointer, such as a mouse pointer or cursor, around to different areas of the screen. Also, a user may want to scroll through the content, either moving the content vertically or horizontally. For example, the user may want to display content that is not shown on the screen.

A user may use a mouse to perform the navigation. The mouse is typically a separate device from the computing device and may be physically moved to move the pointer on the screen. Also, a scrolling device on the mouse may be used to scroll through the content. Using a separate mouse may not always be feasible especially when the computing device being used is a portable device, such a portable personal computer or cellular phone.

### SUMMARY

In one embodiment, a computing device for providing navigation on a display is provided. The computing device includes a first input device that provides navigation on the display screen in two dimensions. For example, the first input device may be a trackstick or track ball that can be mechanically actuated by a user. When actuated, the first input device may cause a pointing device to move in two dimensions, such as in the X-Y directions. Also, a second input device is provided that is configured to provide navigation on the display screen in one dimension. For example, the second input device may be a scrollwheel that provides movement in the vertical or horizontal direction. In one example, a user may scroll through content displayed on the display screen by actuating the second input device. For example, the user may turn the scrollwheel in one direction to scroll through content on the display screen. The second input device is situated around the first input device and is configured to be physically turned around the first input device. The scrollwheel may be circular in shape and have an aperture substantially in the middle thereof wherein a trackstick may be situated substantially in the middle thereof. The scrollwheel may be turned around an axis, such as it may be turned in the clockwise or counter-clockwise direction around the trackstick. Other combinations of input devices may include (a) a click (left or right), (b) 1-D motion input devices (pan, scroll, zoom), (c) 2-D motion input devices (e.g., trackpads, tracksticks).

Accordingly, a compact design for a navigation system is provided. For example, a portable computing device may have limited keyboard real estate. Thus, the scrollwheel and trackstick together take up a minimal amount of space. Also, because of the design, the chance of accidentally actuating one of the trackstick or scrollwheel is limited. For example, a user may be turning the scrollwheel around the trackstick with his/her finger and the chance that the finger may hit the trackstick may be low because the user is naturally moving around the trackstick. Also, because the scrollwheel is mechanical, when the user is actuating the trackstick, accidental movement of the scrollwheel by the user is limited because the scrollwheel needs to be mechanically turned. Accordingly, a compact design in addition to providing effective navigation is provided.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is an example of a computing device according to one embodiment.

FIG. 2 depicts an example of navigational control that can be provided using a navigational system.

FIG. 3 shows an example of computing device according to one embodiment.

FIG. 4 depicts an example of a method for providing navigational control.

FIG. 5 shows an example device that may include a display according to one embodiment of the present invention.

### DETAILED DESCRIPTION OF EMBODIMENTS

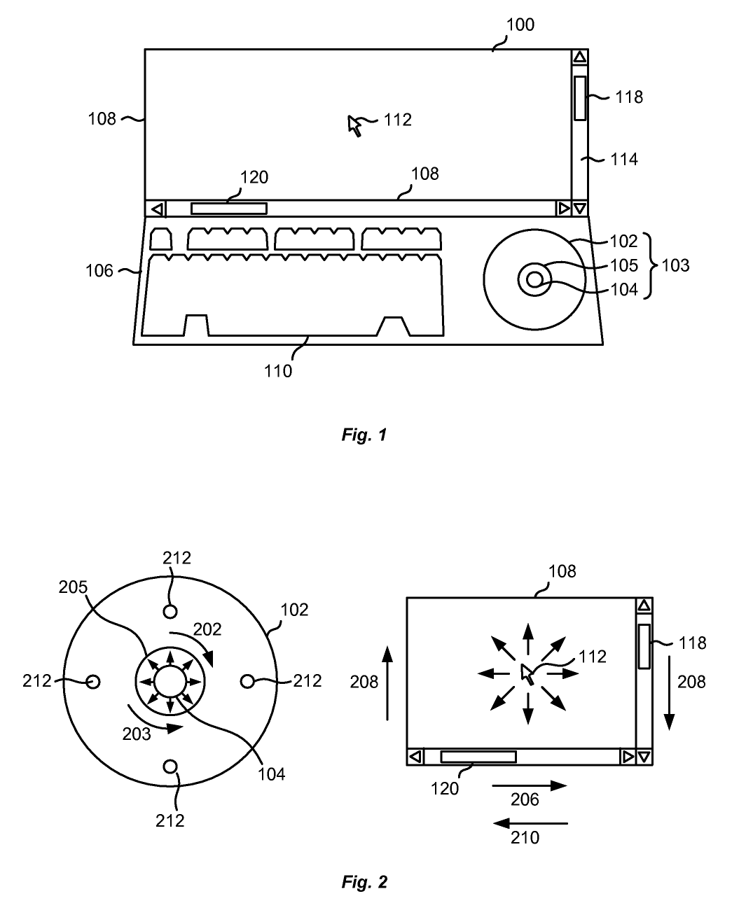

FIG. 1 is an example of a computing device 100 according to one embodiment. A navigational system 103 is provided that includes a first input device 102 and a second input device 104.

Navigational system 103 may provide different ways of input for display screen 108. The input may be (a) a click (left or right), (b) 1-D motion input devices (pan, scroll, zoom), (c) 2-D motion input devices (e.g., trackpads, tracksticks). For example, second input device 104 may provide navigation for display screen 108 in two dimensions, such as the X-Y directions. First input device 102 may provide navigation in one dimension, such as in the vertical direction or horizontal direction.

The input devices may be physical or capacitive. Different combinations may include two click input devices (a-a), a click input device and a 2-D motion device (a-c), a 1-D motion device and click input device (b-a), two 1-D motion devices (b-b), a 1-D motion device and a 2-D motion device (b-c), a 2-D motion device and a click input device (c-a), two 2-D motion devices (c-c), etc. It should be noted that input devices in the combinations may be reversed also.

The click input devices may be devices that provide a single input, such as a selection or click. This may be a binary input, such as a “1” or “0”. In one example, a number of selection buttons can be selected. The input buttons may be physical or soft keys. The buttons may be right and/or left keys that can be “clicked” or selected.

The 1-D motion input device provides movement in one dimension. For example, the 1-D input device allows a user to control a user interface to pan, scroll, or zoom. The 1-D motion input device may be physical or capacitive. The one dimension may be the x direction or y direction (up and down or left and right).

The 2-D motion input device provides movement in two dimensions. For example, the 2-D input device may include a trackpad or trackstick. The two dimensions may be the x and y directions on the display screen. The 2-D motion input device may be mechanical such as in a trackstick or capacitive such as in a trackpad.

First input device 102 may surround second input device 104. For example, first input device 102 is circular in shape and has an aperture 105. Second input device 104 may be found in aperture 105. This structural combination may be used to cover the functions of the different input devices described above. The different combinations will now be discussed in more detail. For the a-b combination, first input device 102 provides a scrollwheel on the outside and second input function provides a click input function. First input device 102 may be mechanical or capacitive. In one embodiment, first input device 102 is mechanical. Second input device 104 may be mechanical or capacitive also.

For the a-a combination, first input device 102 and second input device 104 provide click inputs. For example, first input device 102 may be a right click and second input device 104 may be a left click as is known to be offered on computers or a mouse. The circular area of first input device 102 may be selected on any point to provide a right click. The inner portion that includes second input device 104 may also be selected to provide a left click.

For the a-c combination, second input device 104 provides a click input function and first input device 102 provides a 2-D motion control function. First input device 102 may be a trackpad or include a trackstick that can be used to control display in two dimensions. The user can move a finger around the scrollwheel for movement in one direction. Also, the finger may be moved back and forth for movement in another direction.

For the b-a combination, second input device 104 provides a 1-D motion function and first input device 102 provides a click input function. Second input device 104 may be a device that allows scrolling or zooming in 1-D such as a trackstick. On the outside of it, first input device 102 may be used to provide a click.

For the b-b combination, second input device 104 provides a 1-D motion function and first input device 102 provides a 1-D motion function. First input device 102 may allow a user to run their finger around a scrollwheel to provide the 1-D input. Also, second input device 104 may also allow 1-D motion using a button, trackstick or other means.

For the c-a combination, second input device 104 provides a 2-D motion function and first input device 102 provides a click input function. First input device 102 may be clicked at any point around the circular area. Second input device 104 may be a trackstick that can be actuated for the 2-D motion.

For the c-c combination, second input device 104 provides a 2-D motion function and first input device 102 provides a 2-D function. First input device 102 may be a trackpad that allows 2-D input around the circular area. Second input device 104 may be a trackstick or trackball that can be actuated for the 2-D motion.

For the c-b combination, second input device 104 provides a 1-D motion function and first input device 102 provides a 2-D motion function. First input device 102 may be a trackpad that allows 2-D input around the circular area. Second input device 104 may be a trackstick or trackpad that can be actuated for the 1-D motion.

A more specific example of the combination b-c will now be described. For discussion purposes and clarity, first input device 102 will be referred to as scrollwheel 102 and second input device 102 will be referred to as trackstick 104. However, it will be understood that scrollwheel 102 and trackstick 104 are not limited to being a scrollwheel and a trackstick. For example, trackstick 104 may be a track ball, an elastomer, etc. Also, scrollwheel 102 may be a flat wheel that includes a latch or handle, or may be any other device that can be turned around an axis. Also scrollwheel 102 and trackstick 104 may be switched into different combinations as described above.

Scrollwheel 102 may circular in shape such that it may be turned around an axis in the middle of it. As shown, scrollwheel 102 may include an aperture 105 substantially in the middle of scrollwheel 102. The axis that scrollwheel 102 turns around may be situated in aperture 105. For example, scrollwheel 102 may be of a disk or donut shape and may be installed on a surface of computing device 100, where it may be flush with the surface, on top of, inlaid, etc. Scrollwheel 102 may turn or spin in a plane that is substantially parallel to the surface. Also, scrollwheel 102 may be other shapes, such as oval in shape, or any other shape that can be turned around an axis.

Scrollwheel 102 may be a device that can be mechanically actuated. For example, the user may use his/her finger to turn scrollwheel 102 in a counter-clockwise direction or clockwise direction. In one embodiment, scrollwheel 102 is mechanical in that by physically turning scrollwheel 102, scrolling on display screen 108 is provided. In one embodiment, scrollwheel 102 may not be a capacitive scrollwheel. A capacitive scrollwheel may be touch sensitive where the movement of a finger or other device over the surface of the scrollwheel may cause the scrolling (i.e., mechanical actuation is not needed to cause the scrolling). In contrast, a mechanical scrollwheel is physically turned to cause the scrolling. Although a mechanical scrollwheel is described, it will be understood that embodiments may use a non-mechanical scrollwheel.

Scrollwheel 102, when turned, causes movement of content displayed on display screen 108. In one embodiment, in a scrolling area 114, a scroll bar 118 may be moved vertically when scrollwheel 102 is moved. Scrollwheel 102 may cause movement of content up and down as can be performed if pointing device 112 moved the scroll bar 118 up and down. Thus, the scrolling may be performed automatically by turning scrollwheel 102. Also, scrolling may be performed in the horizontal direction. For example, the scrolling may be performed automatically using scrollwheel 102 just as if pointing device 112 moved scroll bar 120 to the right-hand side thereby displaying content off-screen on the right-hand side. Scrolling is known in the art and a person skilled in the art would appreciate how to scroll through content on display screen 108.

Trackstick 104 is situated in aperture 105. For example, trackstick 104 may be situated substantially in the middle of scrollwheel 102. Trackstick 104 may be actuated in the X-Y directions. In one embodiment, movement of trackstick 104 causes navigation of an object displayed on display screen 108. For example, a pointing device 112 may be moved according to the movement of trackstick 104. Pointing device 112 may be a mouse pointer, cursor, an icon, or any other information displayed on display screen 108.

Navigation system 103 may be found in an input area 106. Input area 106 may include a keyboard 110. In one embodiment, input area 106 may be found in a portable computing device. For example, the portable computing device may include a portable personal computer, cellular phone, personal digital assistant (PDA), etc. In one embodiment, the surface area or real estate in which to place keyboard 110 and navigational system 103 may be limited. For example, keys found in keyboard 110 may surround navigational system 103. Accordingly, it may be important that unnecessary actuation of scrollwheel 102 or trackstick 104 is not received while user is using keyboard 110. For example, a user may be typing on keyboard 110 and moving fingers around navigational system 103. As fingers are moved across navigational system 103, it may be desirable that scrollwheel 102 or trackstick 104 not cause unwanted navigation because the user may not intend to move pointing device 112 or to scroll. Accordingly, by having scrollwheel 102 and trackstick 104 be mechanical, the chance of unwanted actuation is limited. For example, if a finger passes over scrollwheel 102, the turning of scrollwheel 102 may be minimal. This may have been different if scrollwheel 102 was a touch-sensitive device because then a finger sliding over scrollwheel 102 may have scrolled the content of the display significantly. Also, if trackstick 104 is accidentally hit, pointing device 112 may move slightly but not very much, which may not materially affect what the user is doing (i.e., the cursor may move slightly but it may not affect what the user is typing).

FIG. 2 depicts an example of navigational control that can be provided using navigational system 103. As shown, scrollwheel 102 may be moved in a direction 202, which is a clockwise direction that spins around an axis. For example, a user may use a finger to spin scrollwheel 102 around one or more times. When scrollwheel 102 is moved in direction 202, content on display screen 108 is scrolled. For example, content may be scrolled downward as shown by direction 204. In this case, content may be automatically moved downward to display content that may be off-screen below display screen 108. Also, if scrollwheel 102 is being scrolled in the horizontal direction, then content may be scrolled in the direction 206. In this case, content that may be off-screen on the right side of the display screen may be scrolled to be visible in display screen 108. In another embodiment, scrollwheel 102 may be actuated in a direction 203. In this case, content may be scrolled in the direction 208 if the scrolling is vertical or direction 210 if the scrolling is horizontal.

Also, scrollwheel 102 may provide a selection command or any other command when buttons 212 are pressed. For example, scrollwheel 102 may be pressed downward in any of the positions 212 to indicate a selection. For example, if the user presses down at position 212, then this corresponds to selecting the enter key on the keyboard or a mouse button.

Trackstick 104 may be actuated in any of the X-Y directions. This causes pointing device 112 to move on display screen 108. As shown, pointing device 112 may be moved around content displayed on display screen 108.

As shown, trackstick 104 is situated in aperture 205 and can be moved in the direction shown by the arrows. Because scrollwheel 102 is turned in directions 202 or 203, movement of trackstick 104 is less likely to move scrollwheel 102.

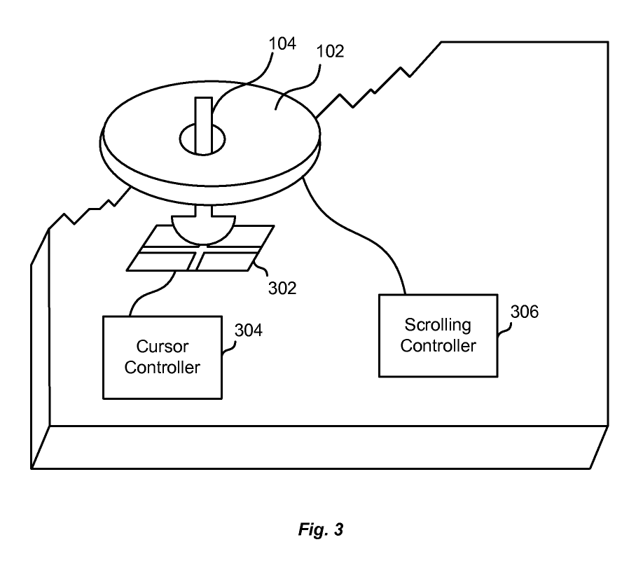

FIG. 3 shows an example of computing device 100 according to one embodiment. As shown, a circuit board 302, pointer controller 304 and a scrolling controller 306 are provided. These components may be found in computing device 100.

Circuit board 302 is configured to communicate movement of trackstick 104 to cursor controller 304. For example, as trackstick 104 is moved in the X-Y direction, it may contact circuit board 302 in different areas. Signals are sent to cursor controller 304, which can then interpret the signals to cause movement of pointing device 112. For example, the pointer may be moved according to the movement detected on circuit board 302.

Also, when scrollwheel 102 is turned, it is detected by scrolling controller 306. Scrolling controller 306 may then cause scrolling of display screen 108 according to characteristics of actuation that is detected. For example, the amount of content scrolled is dependent on how much the wheel is turned.

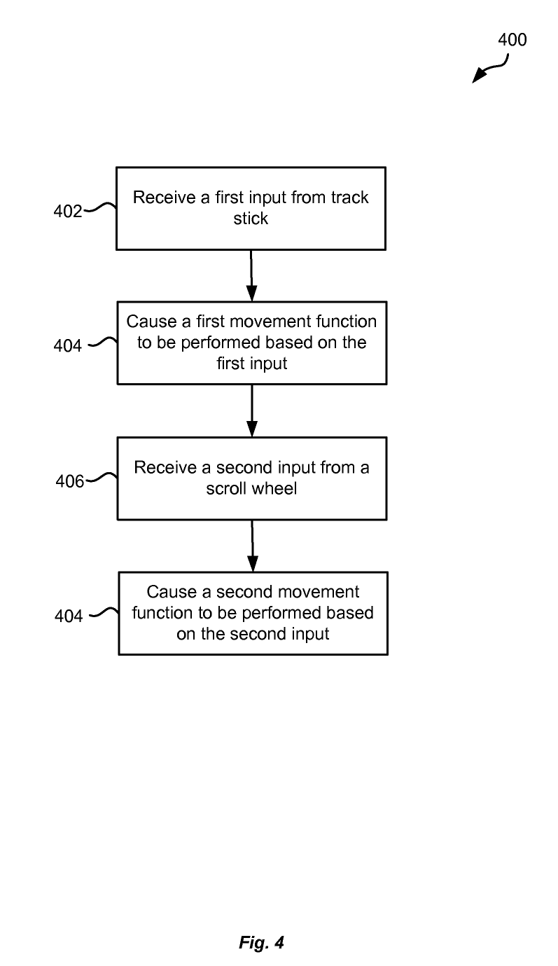

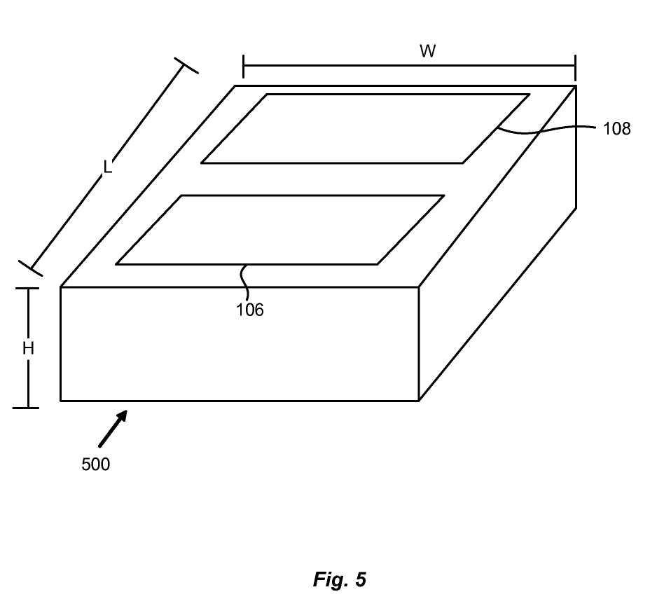

FIG. 4 depicts an example of a method 400 for providing navigational control. Step 402 receives a first input from trackstick 104. For example, the input may be a user actuating trackstick 104.

Step 404 causes a first movement function to be performed based on the first input. For example, the first movement function may move an object in two dimensions, such as moving pointing device 112 on display screen 108.

Step 406 then receives a second input from scrollwheel 102. For example, the user may be turning scrollwheel 102.

Step 408 causes a second movement function to be performed based on the second input. For example, the content on display screen 108 may be scrolled in one direction.

Particular embodiments provide many advantages. For example, when keyboard real estate is limited, an efficient use of space is provided by including a scrollwheel with the trackstick in the middle of it. Thus, scrolling may be performed in addition to using the trackstick in a small amount of space. However, even though these two devices may be closely situated, accidental scrolling or movement of the trackstick is minimized. For example, because scrollwheel 102 needs to be turned in a circular direction, when someone is using trackstick 104, accidental movement of scrollwheel 102 is limited. Further, because scrollwheel 102 moves around trackstick 104, actuation of trackstick 104 is also limited when using scrollwheel 102. Also, different unique combinations of input devices are provided.

FIG. 5 shows an example device 500 that may include display 100 according to one embodiment of the present invention. In one embodiment, device 500 may be a portable device. In other embodiments, device 500 is not limited to portable devices and may be used in any display device, such as a laptop computer, television, DVD display player, etc.

In one embodiment, the dimensions of device 500 may be a length, L, of substantially 4 inches; a width, W, of substantially 3 inches; and a height, H, of substantially ¾ inches. Additionally, the display may be a little under substantially 3 inches wide and substantially 4 inches long.

Although the description has been described with respect to particular embodiments thereof, these particular embodiments are merely illustrative, and not restrictive. Although device 500 is described, it will be understood that any device with a display may use techniques described in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus comprising:
a first input device configured to provide navigation on a display screen of a computing device in one dimension; and
a second input device configured to provide navigation on the display screen of the computing device in two dimensions,
wherein the second input device is situated around the first input device and is configured to be turned around the first input device.

2. The apparatus of claim 1, wherein the first input device comprises a trackstick or track ball.

3. The apparatus of claim 1, wherein when the first input device is actuated, the navigation on the display comprises moving a pointing device according to the actuation.

4. The apparatus of claim 1, wherein the second input device comprises a scrollwheel.

5. The apparatus of claim 1, wherein when the second input device is turned, the navigation on the display is in a vertical direction or horizontal direction.

6. The apparatus of claim 1, wherein the two dimensions comprises X-Y directions.

7. The apparatus of claim 1, wherein the first input device comprises a mechanical input device and the second input device comprises a mechanical input device.

8. A computing device comprising:
a display screen; and
a navigational system comprising:
a first input device configured to provide navigation on the display screen of a computing device in on dimension; and
a second input device configured to provide navigation on the display screen of the computing device in two dimensions,
wherein the first input device is situated around the second input device and is configured to be turned around the second input device.

9. The computing device of claim 8, wherein the first input device comprises a mechanical input device and the second input device comprises a mechanical input device.

10. A method comprising:
receiving a first input for a first input device;
causing a one dimensional movement function on a display screen to be performed based on the first input;
receiving a second input for a second input device; and
causing a two dimensional movement function on the display screen to be performed based on the second input,
wherein the first input device is situated around the second input device and is configured to be turned around the second input device.

11. The method of claim 10, wherein the first input device comprises a trackstick and the second input device comprises a scrollwheel.

12. An apparatus comprising:
a first input device configured to provide a first function on a display screen of a computing device; and
a second input device configured to provide a second function on the display screen of the computing device,
wherein the first input device is situated around the second input device and the first input device and second input device are selected from a group including a click input device, a 1-D input device, and a 2-D input device.

13. The apparatus of claim 12, wherein the first input device comprises a 2-D input device and the second input device comprises a click input device, the 2-D input device being a mechanical input device.

14. The apparatus of claim 12, wherein the first input device comprises a click input device and the second input device comprises a click input device.

15. The apparatus of claim 12, wherein the first input device comprises a click input device and the second input device comprises a 2-D input device.

16. The apparatus of claim 12, wherein the first input device comprises a click input device and the second input device comprises a 1-D input device.

17. The apparatus of claim 12, wherein the first input device comprises a 1-D input device and the second input device comprises a 1-D input device.

18. The apparatus of claim 12, wherein the first input device comprises a 2-D input device and the second input device comprises a 1-D input device.

19. The apparatus of claim 12, wherein the first input device comprises a 1-D input device and the second input device comprises a 2-D input device.

20. The apparatus of claim 12, wherein the first input device comprises a 2-D input device and the second input device comprises a 2-D input device.
